(19) United States
(12) Patent Application Publication
(10) Pub. No.: US 2021/0302065 A1
(43) Pub. Date: Sep. 30, 2021

(54) Segmented PTC Heating Element Array

(71) Applicant: World & Main (Cranbury) LLC, Cranbury, NJ (US)

(72) Inventor: John H. Bavoso, Hamilton Square, NJ (US)

(21) Appl. No.: 17/202,161

(22) Filed: Mar. 15, 2021

Related U.S. Application Data
(60) Provisional application No. 63/002,951, filed on Mar. 31, 2020.
(60) Provisional application No. 63/002,958, filed on Mar. 31, 2020.
(60) Provisional application No. 63/002,965, filed on Mar. 31, 2020.

(51) Int. Cl. F24H 3/04; H05B 1/02

(52) U.S. Cl. CPC F24H 3/0417; H05B 1/0277; H05B 2203/005; H05B 2203/02; H05B 2203/022; F24H 2250/04

(57) ABSTRACT

A PTC heating appliance has a heating element array including a first plurality of PTC chips stacked into a second plurality of columns and including porous heat-exchanging radiators each in thermal communication with one or more of the columns and arranged such that heat produced by any of the PTC chips is conducted into the porous heat-exchanging radiator or radiators with which it is in thermal communication. A fan is arranged to force air through the porous heat exchanging radiators such that the heat therein is extracted and blown from the appliance. A control is adapted to cause selective energization of sub-groups of the PTC chips and has at least a high and a low setting. A higher number of the PTC chips are energized during the high setting than during the low setting, and each subgroup includes at least one PTC chip of each column.

### FIELD OF THE INVENTION

The present invention is related to heating appliances. More specifically, it is related to circuitry for portable electric positive-temperature-coefficient (PTC) room heaters.

### BACKGROUND

PTC room heaters are well known. Such heaters typically include several columns of PTC heating chips which together draw 1500 W of electricity in total and convert that to heat because 1500 W is the maximum allowed by any unattended and continuously operating electrical appliance. A fan positioned behind the PTC elements forces air through the elements whereby the air is heated and dispersed forwardly from the heater. 1500 W may overheat a small room and may be too hot for persons, especially disabled persons, sitting nearby, so such heaters often include one or more lower wattage settings in which fewer of the columns of PTC elements are energized.

PTC heating chips as used in electrical heating appliances are well known and for brevity will not be further explained here. Reference is made to URL https://en.wikipedia.org/wiki/Ceramic_heater, the teachings of which are incorporated herein by reference.

A drawback in such arrangement is that the airflow being dispersed during the lower wattage operation is warm if it has passed through one of the energized columns but cold if it has passed through one of the de-energized columns, which creates discomfort.

There exists a need for, and it is an object of the invention to provide, a heating appliance that provides an even temperature across its entire airflow during any wattage setting.

Further needs and objects exist which are addressed by the present invention, as may become apparent upon review of the included disclosure of exemplary embodiments thereof.

### SUMMARY OF THE INVENTION

The invention may be embodied in or practiced using an electrical heating appliance having improvements which may include a segmented PTC heating element that more evenly heats the air flowing through it by having strategically positioned elements energized during lower wattage settings.

The invention may also be embodied in or practiced using a PTC heating appliance having a heating element array including a first plurality of PTC chips stacked into a second plurality of columns and including porous heat-exchanging radiators each in thermal communication with one or more of the columns and arranged such that heat produced by any of the PTC chips is conducted into the porous heat-exchanging radiator or radiators with which it is in thermal communication; a fan arranged to force air through the porous heat exchanging radiators such that the heat therein is extracted and blown from the appliance; and a control adapted to cause selective energization of sub-groups of the PTC chips and having at least a high and a low setting. A higher number of the PTC chips may be energized during the high setting than during the low setting. Each subgroup may include energized PTC chips distributed evenly about the array.

The heat exchanging radiators may be formed of thin aluminum finning arranged in a serpentine shape and soldered to aluminum sidewalls. The PTC chips may be placed against the sidewalls with a layer of thermal conduction paste between.

The controller may be a switch having an off position during which the PTC chips and the fan are not energized and having a high position adapted to cause the high power setting and a low position adapted to cause the low power setting. The switch further may have a medium position adapted to cause a medium power setting during which less of the PTC chips are energized than during the high setting and more of the PTC chips are energized than during the low setting number.

The energized PTC chips may be distributed evenly about the array during the medium setting. During the high power setting all PTC chips may energized so that all porous heat-exchanging radiators are heated evenly across the array, during the medium setting the uppermost and lowermost PTC chips of the outermost columns and the innermost chips of the innermost columns may be energized so that all porous heat-exchanging radiators are less heated evenly across the array, and during the low setting the energized PTC chips may be distributed evenly about the array so that the entire heating element array is even less heated evenly across the array.

The invention may also be embodied in or practiced using a PTC heating appliance having a heating element array including a first plurality of PTC chips stacked into a second plurality of columns and including porous heat-exchanging radiators each in thermal communication with one or more of the columns and arranged such that heat produced by any of the PTC chips is conducted into the porous heat-exchanging radiator or radiators with which it is in thermal communication. A fan may be arranged to force air through the porous heat exchanging radiators such that the heat therein is extracted and blown from the appliance. A control may be is adapted to cause selective energization of sub-groups of the PTC chips and has at least a high and a low setting. A higher number of the PTC chips may be energized during the high setting than during the low setting. Each subgroup may include at least one PTC chip of each column.

The heat exchanging radiators may be formed of thin aluminum finning arranged in a serpentine shape and soldered to aluminum sidewalls. The PTC chips may be placed against the sidewalls with a layer of thermal conduction paste between.

The controller may be a switch having an off position during which the PTC chips and the fan are not energized and having a high position adapted to cause the high power setting and a low position adapted to cause the low power setting. The switch may further have a medium position adapted to cause a medium power setting during which less of the PTC chips are energized than during the high setting and more of the PTC chips are energized than during the low setting. At least one PTC chip may be energized in each column during the medium setting.

During the high power setting all PTC chips may be energized so that all porous heat-exchanging radiators are heated evenly across the array. During the medium setting the uppermost and lowermost PTC chips of the outermost columns and the innermost chips of the innermost columns may energized so that all porous heat-exchanging radiators are less heated evenly across the array. And during the low setting one PTC chip in each column may be energized so that the entire heating element array is even less heated evenly across the array.

Further features and aspects of the invention are disclosed with more specificity in the Detailed Description and accompanying drawings of an exemplary embodiment provided herein.

### BRIEF DESCRIPTION OF THE DRAWINGS

Many aspects of the invention can be better understood with reference to the included Drawings showing an exemplary embodiment for practicing the invention which corresponds to the accompanying Detailed Description. The components in the Drawings are not necessarily to scale, emphasis instead being placed upon clearly illustrating the principles of the invention. Moreover, like reference numerals in the Drawings designate corresponding parts throughout the several views.

FIG. 1 is a perspective view of a portable electric heating appliance according to or for use in practicing the invention

FIG. 2 is a front view of the appliance of FIG. 1;

FIG. 3 is a top view of the appliance of FIG. 1;

FIG. 4 is a partial exploded view of the appliance of FIG. 1;

FIG. 5A is a view of the heating element array of the appliance of FIG. 1 during high heat mode;

FIG. 5B is a view of the heating element array of the appliance of FIG. 1 during medium heat mode;

FIG. 5C is a view of the heating element array of the appliance of FIG. 1 during low heat mode;

FIG. 6 is a full side cross section of the appliance of FIG. 1;

FIG. 7 is a circuit diagram for the appliance of FIG. 1;

FIG. 8A is a view of an alternate heating element array of the appliance of FIG. 1 during high heat mode;

FIG. 8B is a view of the alternate heating element array of the appliance of FIG. 1 during medium heat mode; and

FIG. 8C is a view of the alternate heating element array of the appliance of FIG. 1 during low heat mode.

### DETAILED DESCRIPTION OF AN EXEMPLARY EMBODIMENT

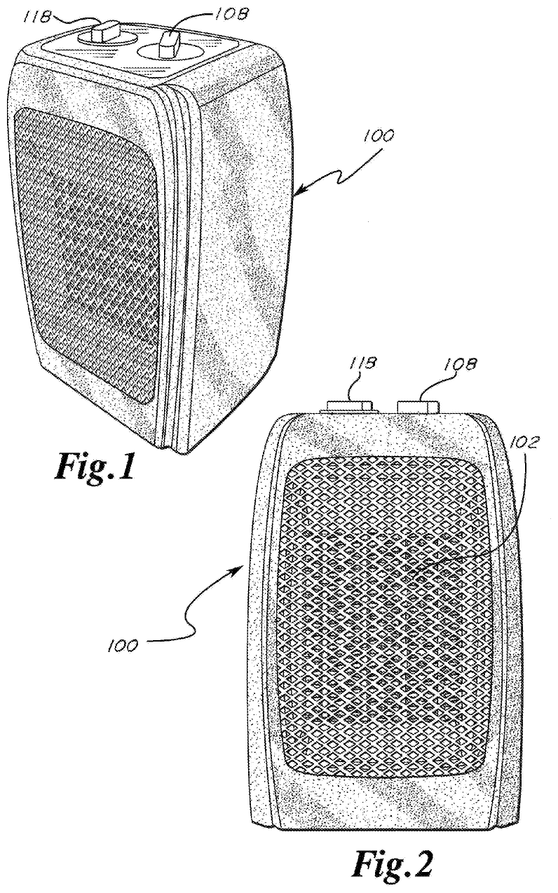

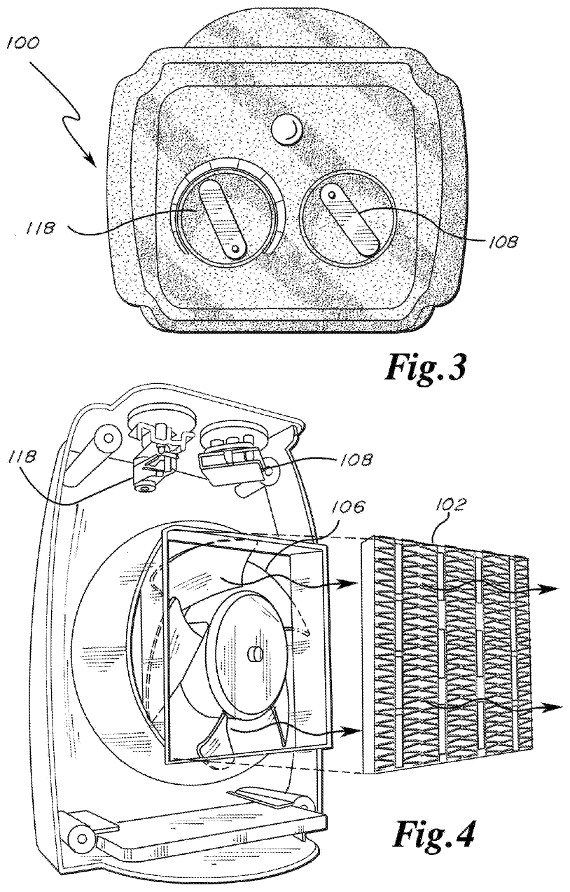

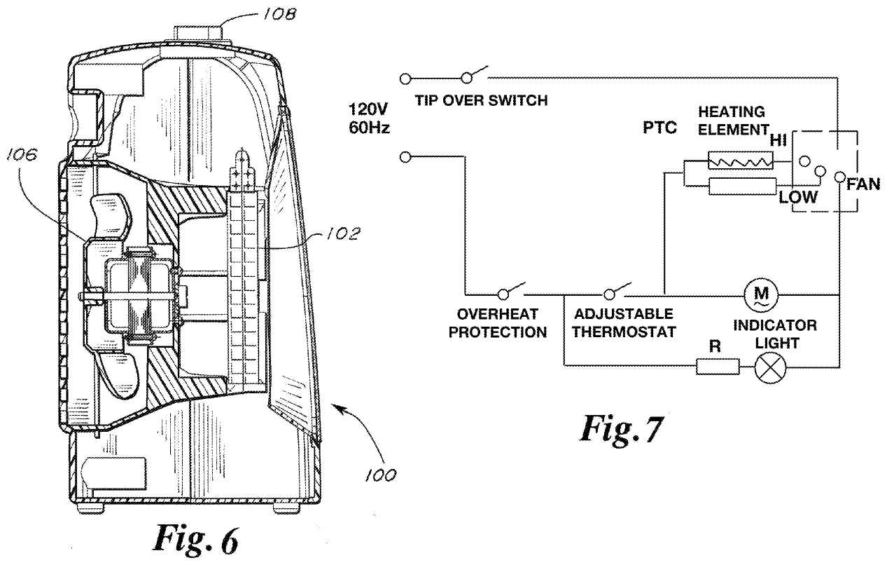

A PTC heating appliance 100 is shown in FIGS. 1 through 8C, which has a segmented PTC heating element array 102. The heating appliance may have any one of many shapes, configurations, and control panel arrangements, with those shown being merely exemplary as shown throughout the accompanying images.

The heating element array includes sixteen PTC chips 104 stacked into four columns and five porous heat-exchanging radiators 105 between and adjacent the columns. It is the nature of the PTC chips that a voltage there-across will cause the chip to become hot, and that heat will conduct to the heat radiator/radiators with which it is in contact. The radiators are formed of thin aluminum finning 112 arranged in a serpentine shape and soldered to aluminum sidewalls 114. The PTC chips are placed against the sidewalls with a layer of thermal conduction paste 116 between. The high thermal coefficient of the aluminum ensures that heat from the energized chips is instantly conducted into through the radiators. Fan 106 forces air through the porous radiators to extract the heat therefrom whenever one or more of the PTC chips are energized, then forces that air forwardly from the appliance and into the surrounding environment. Control switch 108 has an Off position during which the PTC chips and the fan are not energized and has High Power, Medium Power, and Low Power positions, each energizing the fan and energizing a different subgroup of the PTC chips. Adjustable thermostat 118 temporarily de-energizes the PTC chips and fan when the ambient temperature has reached a desired level and re-energizes them when the ambient temperature drops.

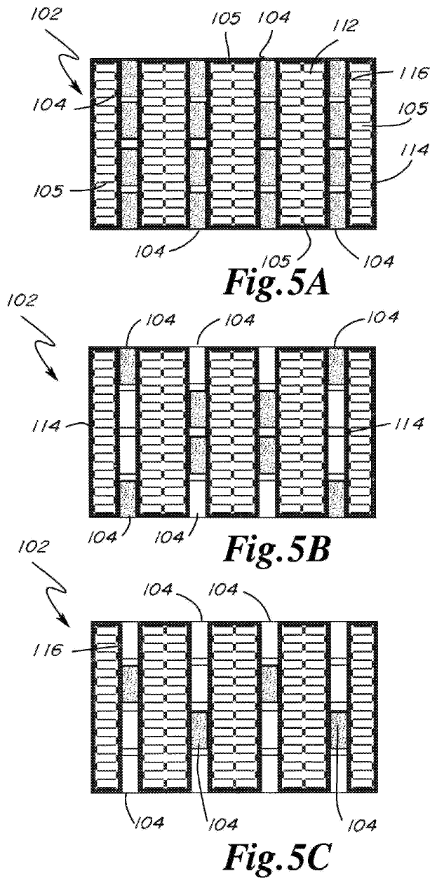

Referring to FIGS. 5A to 5C, the energization of particular PTC chips (subgroups) during each of three power modes is shown; High Power (FIG. 5A) Medium Power (FIG. 5B) and Low Power (FIG. 5C). To demonstrate the state of each chip, energized chips are dark and de-energized chips are light.

During the High Power mode of FIG. 5A, all PTC chips are energized so that all five radiators and the entire heating element array is heated, and all air passing therethrough will become hot. During the Medium Power mode of FIG. 5B, the uppermost and lowermost PTC chips of the outermost columns and the innermost chips of the innermost columns are energized so that the entire heating element array is heated to a lesser temperature, and all air passing therethrough will become warm-to-hot. During the Low Power mode of FIG. 5C, a staggered row has one PTC chip energized in each column so that the entire heating element array is warmed to an even lesser temperature, and all air passing therethrough will become warm.

It should be appreciated that the distribution of energized PTC chips in each mode maximizes the evenness by which the array is heated or warmed. This arrangement in combination with the thermal conductivity of the aluminum finning eliminates cold zones in the airflow and maximizes the comfort realized by those in proximity to the appliance.

FIG. 7 is the circuit diagram of appliance 100.

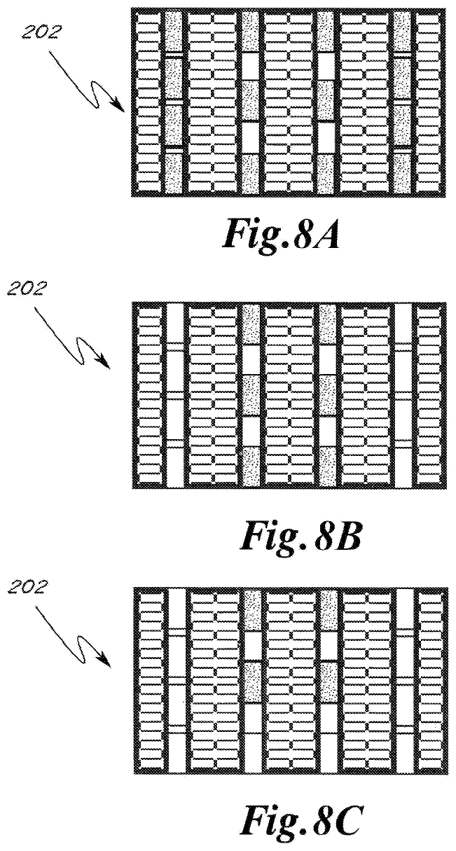

Referring to FIGS. 8A to 8C, the energization of particular PTC chips (subgroups) during each of three power modes of an alternate heating element array 202 is shown; High Power (FIG. 8A) Medium Power (FIG. 8B) and Low Power (FIG. 8C). To demonstrate the state of each chip, energized chips are dark and de-energized chips are light.

Various changes in form and detail may be made without departing from the spirit and scope of the invention, so the invention should therefore only be considered according to the following claims, including all equivalent interpretation to which they are entitled.

I claim:

1. A PTC heating appliance comprising:
a heating element array including a first plurality of PTC chips stacked into a second plurality of columns and including porous heat-exchanging radiators each in thermal communication with one or more of the columns and arranged such that heat produced by any of the PTC chips is conducted into the porous heat-exchanging radiator or radiators with which it is in thermal communication;
a fan arranged to force air through the porous heat exchanging radiators such that the heat therein is extracted and blown from the appliance; and
a control adapted to cause selective energization of sub-groups of the PTC chips and having at least a high and a low setting; wherein
a higher number of the PTC chips is energized during the high setting than during the low setting; and wherein
each subgroup includes energized PTC chips distributed evenly about the array.

2. The PTC heating appliance of claim 1 in which the heat exchanging radiators are formed of thin aluminum finning arranged in a serpentine shape and soldered to aluminum sidewalls.

3. The PTC heating appliance of claim 2 in which the PTC chips are placed against the sidewalls with a layer of thermal conduction paste between.

4. The PTC heating appliance of claim 3 in which the controller is a switch having an off position during which the PTC chips and the fan are not energized and having a high position adapted to cause the high power setting and a low position adapted to cause the low power setting.

5. The PTC heating appliance of claim 4 in which the switch further comprises a medium position adapted to cause a medium power setting during which less of the PTC chips are energized than during the high setting and more of the PTC chips are energized than during the low setting number; and wherein the energized PTC chips are distributed evenly about the array during the medium setting.

6. The PTC heating appliance of claim 5 in which;
during the high power setting all PTC chips are energized so that all porous heat-exchanging radiators are heated evenly across the array;
during the medium setting the uppermost and lowermost PTC chips of the outermost columns and the innermost chips of the innermost columns are energized so that all porous heat-exchanging radiators are less heated evenly across the array; and
during the low setting the energized PTC chips are distributed evenly about the array so that the entire heating element array is even less heated evenly across the array.

7. The PTC heating appliance of claim 1 in which the controller is a switch having an off position during which the PTC chips and the fan are not energized and having a high position adapted to cause the high power setting and a low position adapted to cause the low power setting.

8. The PTC heating appliance of claim 7 in which the switch further comprises a medium position adapted to cause a medium power setting during which less of the PTC chips are energized than during the high setting and more of the PTC chips are energized than during the low setting; and wherein the energized PTC chips are distributed evenly about the array during the medium setting.

9. The PTC heating appliance of claim 8 in which;
during the high power setting all PTC chips are energized so that all porous heat-exchanging radiators are heated evenly across the array;
during the medium setting the uppermost and lowermost PTC chips of the outermost columns and the innermost chips of the innermost columns are energized so that all porous heat-exchanging radiators are less heated evenly across the array; and
during the low setting the energized PTC chips are distributed evenly about the array so that the entire heating element array is even less heated evenly across the array.

10B1. A PTC heating appliance comprising:
a heating element array including a first plurality of PTC chips stacked into a second plurality of columns and including porous heat-exchanging radiators each in thermal communication with one or more of the columns and arranged such that heat produced by any of the PTC chips is conducted into the porous heat-exchanging radiator or radiators with which it is in thermal communication;
a fan arranged to force air through the porous heat exchanging radiators such that the heat therein is extracted and blown from the appliance; and
a control adapted to cause selective energization of sub-groups of the PTC chips and having at least a high and a low setting; wherein
a higher number of the PTC chips is energized during the high setting than during the low setting; and wherein
each subgroup includes at least one PTC chip of each column.

11. The PTC heating appliance of claim 10 in which the heat exchanging radiators are formed of thin aluminum finning arranged in a serpentine shape and soldered to aluminum sidewalls.

12. The PTC heating appliance of claim 11 in which the PTC chips are placed against the sidewalls with a layer of thermal conduction paste between.

13. The PTC heating appliance of claim 12 in which the controller is a switch having an off position during which the PTC chips and the fan are not energized and having a high position adapted to cause the high power setting and a low position adapted to cause the low power setting.

14. The PTC heating appliance of claim 13 in which the switch further comprises a medium position adapted to cause a medium power setting during which less of the PTC chips are energized than during the high setting and more of the PTC chips are energized than during the low setting number; and wherein at least one PTC chip is energized in each column during the medium setting.

15. The PTC heating appliance of claim 14 in which;
during the high power setting all PTC chips are energized so that all porous heat-exchanging radiators are heated evenly across the array;
during the medium setting the uppermost and lowermost PTC chips of the outermost columns and the innermost chips of the innermost columns are energized so that all porous heat-exchanging radiators are less heated evenly across the array; and
during the low setting one PTC chip in each column is energized so that the entire heating element array is even less heated evenly across the array.

16. The PTC heating appliance of claim 10 in which the controller is a switch having an off position during which the PTC chips and the fan are not energized and having a high position adapted to cause the high power setting and a low position adapted to cause the low power setting.

17. The PTC heating appliance of claim 16 in which the switch further comprises a medium position adapted to cause a medium power setting during which less of the PTC chips are energized than during the high setting and more of the PTC chips are energized than during the low setting; and wherein at least one PTC chip is energized in each column during the medium setting.

18. The PTC heating appliance of claim 17 in which;
during the high power setting all PTC chips are energized so that all porous heat-exchanging radiators are heated evenly across the array;
during the medium setting the uppermost and lowermost PTC chips of the outermost columns and the innermost chips of the innermost columns are energized so that all porous heat-exchanging radiators are less heated evenly across the array; and
during the low setting one PTC chip in each column is energized so that the entire heating element array is even less heated evenly across the array.
